(19) United States
(12) Patent Application Publication
(10) Pub. No.: US 2020/0097868 A1
(43) Pub. Date: Mar. 26, 2020

(54) ENHANCED CONSISTENCY IN GEOLOGICAL RISK ASSESSMENT THROUGH CONTINUOUS MACHINE LEARNING

(71) Applicants: International Business Machines Corporation, Armonk, NY (US); Petrogal Brasil, S.A . (GALP), Lisboa (PT)

(72) Inventors: Carlos Raoni de Alencar Mendes, Rio de Janeiro (BR); Rafael Rossi de Mello Brandao, Botafogo (BR); Renato Fontoura de Gusmão Cerqueira, Barra da Tij (BR); Bruno da Costa Flach, Rio de Janeiro (BR); Francisco José Cordeiro Silva, Rua António Albino Machado (PT); Susana de Lurdes Alve Fernandes, Rua Actor Antonio Cardoso (PT); Carolina André Libório, Alcobaça (PT); João Pedro Casacão, Av. Arantes de Oliveira (PT); Joana de Noronha Ribeiro de Almeida, Lisboa (PT); Dario Sergio Cersósimo, Sintra (PT)

(73) Assignees: International Business Machines Corporation, Armonk, NY (US); Petrogal Brasil, S.A . (GALP), Lisboa (PT)

(21) Appl. No.: 16/139,977

(22) Filed: Sep. 24, 2018

(51) Int. Cl. G06Q 10/06; G06F 17/21; G06F 17/30; G06F 15/18

(52) U.S. Cl. CPC G06Q 10/0635; G06Q 10/067; G06F 17/21; G06F 17/30979; G06F 17/3043; G06F 17/30345; G06F 15/18; G06F 17/30569

(57) ABSTRACT

Geological risk assessment includes receiving a first set of geological factors associated with a first site. Data pertaining to at least one second site with a second set of geological factors similar to first set of geological factors of the first site is retrieved. A user input indicating a comparison of the first set of geological factors to the second set of geological factors received, and a level of knowledge of the first site is determined based upon the comparison. A suggested probability of success for the first site is determined based upon the level of knowledge. A probability of success is determined for each of the geological factors of the second set of geological factors. A probability of success for the first site is determined. The probability of success of the first site is assessed based upon the level of knowledge of the first site, the suggested probability of success for the first site, and the probability of success for each of the second set of geological factors.

### TECHNICAL FIELD

The present invention relates generally to a method, system, and computer program product for geological risk assessment. More particularly, the present invention relates to a method, system, and computer program product for enhanced consistency in geological risk assessment through continuous machine learning.

### BACKGROUND

Geological risk assessment (GRA) is a process in which interpreters, usually geoscientists, assign a Probability of Success (POS) of a given prospect containing a recoverable accumulation of hydrocarbons resulting in a geological success. A prospect is an area of exploration or site in which hydrocarbons have been predicted to exist in an economic quantity. Interpreters often base their GRA rationale on the characterization of geological factors and available supporting data for a given prospect. However, different geoscientists may estimate prospect reserves, profitability, and chances of success without consistent methods. The analyzed data is generally unstructured, demanding manual processing of a varied number of documents. Such processing is a costly and time-consuming task. Furthermore, this process commonly involves subjectivity and results may vary depending on the interpreter's expertise.

### SUMMARY

The illustrative embodiments provide a method, system, and computer program product. An embodiment of a computer-implemented method for geological risk assessment includes receiving a first set of geological factors associated with a first site, and retrieving data pertaining to at least one second site with a second set of geological factors similar to first set of geological factors of the first site. The embodiment further includes receiving a user input indicating a comparison of the first set of geological factors to the second set of geological factors, and determining a level of knowledge of the first site based upon the comparison. The embodiment further includes determining a suggested probability of success for the first site based upon the level of knowledge and determining a probability of success for each of the geological factors of the second set of geological factors. The embodiment further includes determining a probability of success for the first site, and assessing the probability of success of the first site based upon the level of knowledge of the first site, the suggested probability of success for the first site, and the probability of success for each of the second set of geological factors.

In another embodiment, the data is retrieved from a knowledge base. Another embodiment further includes updating the knowledge base based on the assessment. Another embodiment further includes receiving unstructured data associated with the second site, converting the unstructured data to structured data, and storing the structured data in the knowledge base. In another embodiment, converting the unstructured data to structured data includes processing the unstructured data using natural language processing techniques.

Another embodiment further includes receiving measurement data associated with the second site, analyzing the measurement data to provide a geological interpretation of the measurement data, and storing the interpreted data in the knowledge base as structured data.

In another embodiment, the comparison is a pair-wise comparison of the first set of geological factors and the second set of geological factors. Another embodiment further includes receiving feedback associated with the assessment of the probability of success of the first site from one or more other users, and adjusting the assessment based on the feedback. In another embodiment, the assessment is performed by a subject-matter expert.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an exemplary architecture for enhanced consistency in geological risk assessment through continuous machine learning in accordance with an illustrative embodiment;

FIG. 4 depicts a block diagram of another exemplary architecture for enhanced consistency in geological risk assessment through continuous machine learning in accordance with an illustrative embodiment;

FIG. 5 depicts an exemplary workflow for geological risk assessment in accordance with an illustrative embodiment;

FIG. 6 depicts an example process for continuous learning in geological factor risk assessment in accordance with an illustrative embodiment;

FIG. 7 depicts an example process for continuous learning in geological factor characterization in accordance with an illustrative embodiment;

FIG. 8 an example process for geological risk reassessment in accordance with an illustrative embodiment;

FIG. 9 depicts an example process for geological factor characterization methodology update in accordance with an illustrative embodiment; and

FIG. 10 depicts a flowchart of an example process for enhanced consistency in geological risk assessment through continuous machine learning in accordance with an illustrative embodiment.

### DETAILED DESCRIPTION

The illustrative embodiments described herein are directed to enhanced consistency in geological risk assessment through continuous machine learning. One or more embodiments recognize that an existing problem is to develop a flexible geological risk assessment (GRA) methodology that is a repeatable and consistent process that avoid biased evaluations and drives a petroleum company to a successful exploration portfolio.

Traditionally, petroleum exploration has been carried through four distinct stages. In a first stage, a basin or trend to explore, also called a “play”, is defined. In a second state, potential candidates for drilling, or prospects, are identified. In a third stage, each of a prospect's respective values, which include estimating the size of the producible reserves, the chance of hydrocarbon accumulation, and profitability, are measured. A fourth stage includes implementation and management of exploration projects. The fourth stage includes defining acquisition strategies, inventory and portfolio management, and finally carrying out operations. Estimating a prospect's value on the chance of hydrocarbon accumulation is referred to as geological risk assessment (GRA).

A traditional GRA workflow begins with data acquisition, for instance, seismic data, well data, scientific papers, etc. Experts then use supporting tools to explore and interpret this data, building geological models and identifying potential drilling prospects. The success of such prospects depends upon the existence of a set of petroleum system elements, or geological factors, e.g. trap, seal, reservoir, recovery effectiveness, etc. A risk assessment is then performed to assign a measure called probability of success (or POS), indicating the chance of a given prospect contains a recoverable accumulation of hydrocarbons. The reliability of the POS estimation is highly dependent of the data used. In this sense, multiple methodologies adopt the concept of a Level of Knowledge (or LOK) metric to assess data availability, quantity and quality. In addition, some of these methodologies use the LOK metric to constrain a possible range of values to be assigned to the POS. Traditionally, this is an iterative process, i.e., when new data is acquired a revision of the whole process could be necessary.

Chance adequacy matrices and risk-tables are among the main used tools that aid experts in providing POS values for prospects. A chance adequacy matrix defines constraints for POS values depending on a level of uncertainty or LOK of geological models derived from available data and its interpretation. The chance adequacy matrix does not provide guidance on how to characterize each prospect or how to define a LOK level for such prospects. In a risk-table, for each geological factor there is a standard characterization process that defines which cell of the table the prospect is associated with. The particular cell has a fixed probability value that should be used to define the POS value for the geological factor of the corresponding prospect. The final POS of the prospect is a multiplication of all POS values of its geological factors.

Accordingly, risk assessment is based on the characterization of specific properties of geological factors and the available supporting data for a given prospect. However, risk assessment is commonly carried out without consistent methods. The analyzed data is generally unstructured which results in a costly and time-consuming task. In addition, the risk assessment process involves subjectivity and results vary depending upon the interpreter's expertise. The standard characterization process and the fixed POS values reduce subjectivity but don't provide the necessary flexibility to adapt to new realities, for instance, adapting to new technology or new exploration frontiers.

One or more embodiments are directed to improving the consistency of the risk assessment process by providing contextually relevant information for the activities within the risk assessment in order to decrease bias in the decision-making process about which prospects to drill. One or more embodiments described a system and methodology for structuring geological prospects and providing a fair ranking/comparison between the prospects by the use of an exemplary advisor system based on artificial intelligence techniques to continuously improve decision making support for each GRA phase. In one or more embodiments, a geological risk assessment is broken down into basic geological factors. For each geological factor, stages of geological factor characterization, level of knowledge (LOK) assessment, probability of success (POS) assessment, and peer review are performed.

In one or more embodiments, a knowledge base (KB) is used to continuously accumulate and structure domain knowledge obtained from multiple sources, such as data analysis modules and papers, providing evidences for the characterization process. In one or more embodiments, the retrieval and ranking of relevant characterization evidences are used to continuously improve geological risk assessment by collecting expert feedback and applying supervised machine learning ranking algorithms.

One or more embodiments provide for a continuous learning process that combines rule-based inference and supervised machine learning methods to establish a fair and consistent ranking of Level of Knowledge based on expert pair-wise comparisons with similar prospects to provide a flexible expert-based ranking of LOK. One or more embodiments provide support to a dynamic characterization methodology that can be adapted and evolve. One or more embodiments provide for assessment tracking supported by a knowledge base, enabling the monitoring of potential resources and concepts that may trigger LOK and POS reassessments.

An embodiment can be implemented as a software application. The application implementing an embodiment can be configured as a modification of an existing system or platform, as a separate application that operates in conjunction with an existing system or platform, a standalone application, or some combination thereof.

The illustrative embodiments are described with respect to certain types of tools and platforms, geological risk assessment procedures and algorithms, services, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

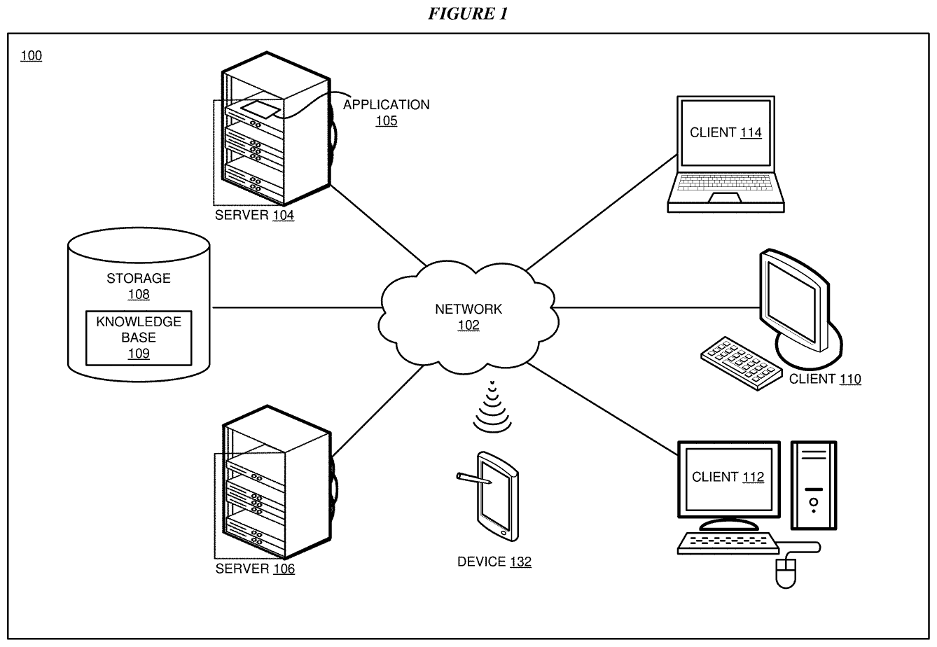

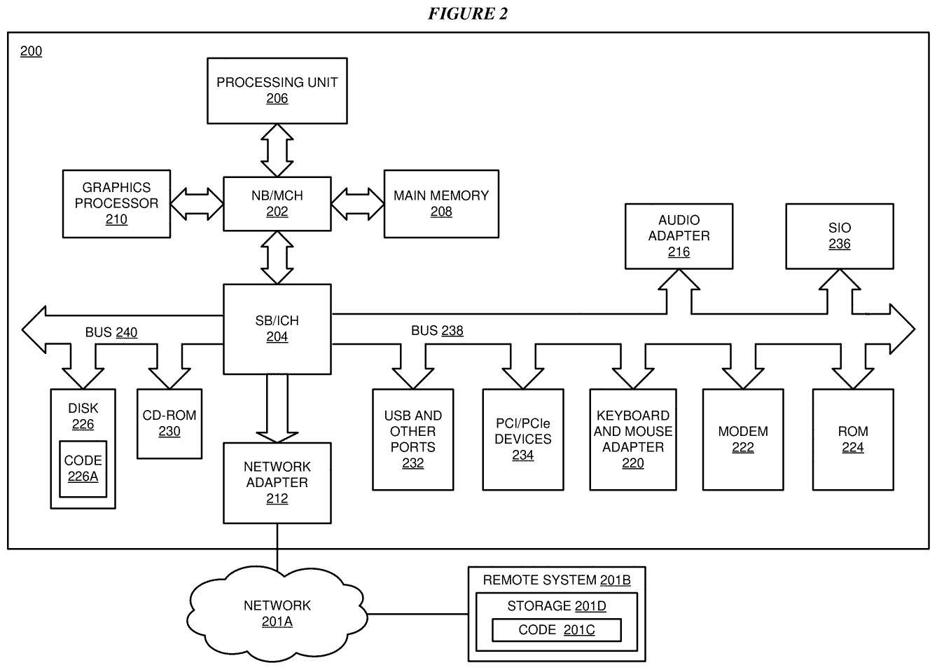

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown. Server 104 includes an application 105 that may be configured to implement one or more of the functions described herein for enhanced consistency in geological risk assessment through continuous machine learning as described herein in accordance with one or more embodiments. Storage device 108 includes one or more knowledge bases 109 configured to store data associated with prospects, geological factors, facts and statements as subject-predicate-object (SPO) triples and references to unstructured data.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid-state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object-oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

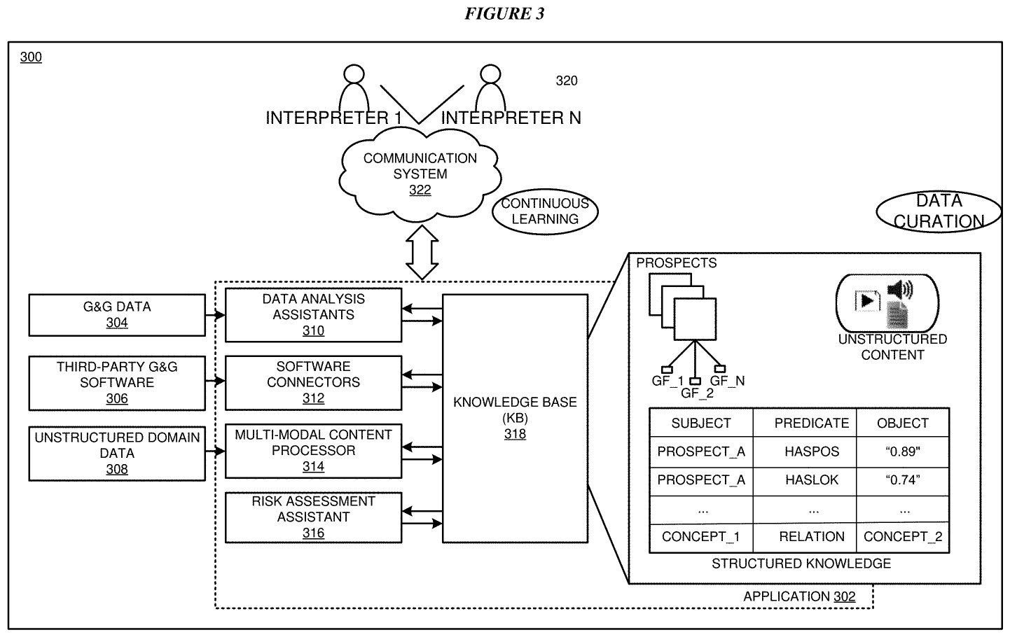

With reference to FIG. 3, this figure depicts a block diagram of an exemplary architecture 300 for enhanced consistency in geological risk assessment through continuous machine learning in accordance with an illustrative embodiment. The example embodiment includes an application 302. In a particular embodiment, application 302 is an example of application 105 of FIG. 1.

In the embodiment, application 302 receives geological and geophysical (G&G) data raw data 304, third-party G&G software inputs 306, and unstructured domain data 308. In particular embodiments, G&G raw data 304 includes measurement data associated with one or more prospects captured from sources such as seismic data and well data from exploration activity, third-party G&G software inputs 306 include geological factors and other data received from third-party G&G software tools, and unstructured domain data 308 includes scientific papers and other unstructured data containing information useful for making risk assessment decisions.

Application 302 includes data analysis assistants 310, software connectors 312, multi-modal content processor 314, risk assessment assistant 316, and a knowledge base (KB) 318. Data analysis assistants 310 are configured to provide geological interpretation of G&G raw data 304 and provides the interpreted G&G raw data to knowledge base 318 as structured data. Software connectors 312 are configured to translate analysis performed in third-party software 306 or other analysis tools to an ontology of KB 318 as structured knowledge in which the ontology encompasses a representation, organization, and relationship of data within KB 318. Multi-modal content processor 314 parses and extracts relevant domain content information from unstructured domain data 308 in a number of different formats and provides the processed domain content information to KB 318 as structured knowledge. Risk assessment assistant 316 uses this accumulated structured knowledge to support the geological risk assessment procedures described herein.

In one or more embodiments, KB 318 stores information about prospects and associated geological factors (GF_1 . . . GF_N), facts and statements as SPO triples, and references to unstructured data that may be connected or associated with one or more prospects. In one or more embodiments, the prospect data is constantly refined and curated by users, making it as consistent as possible in the long run. In one or more embodiments, a plurality of interpreters (Interpreter 1 . . . Interpreter N) 320 may access application 302 via communication system 322 to retrieve risk assessments associated with one or more prospects from KB 318 and review the risk assessments to provide peer feedback for the risk assessments. In particular embodiments, communications system 332 includes network 102 of FIG. 1.

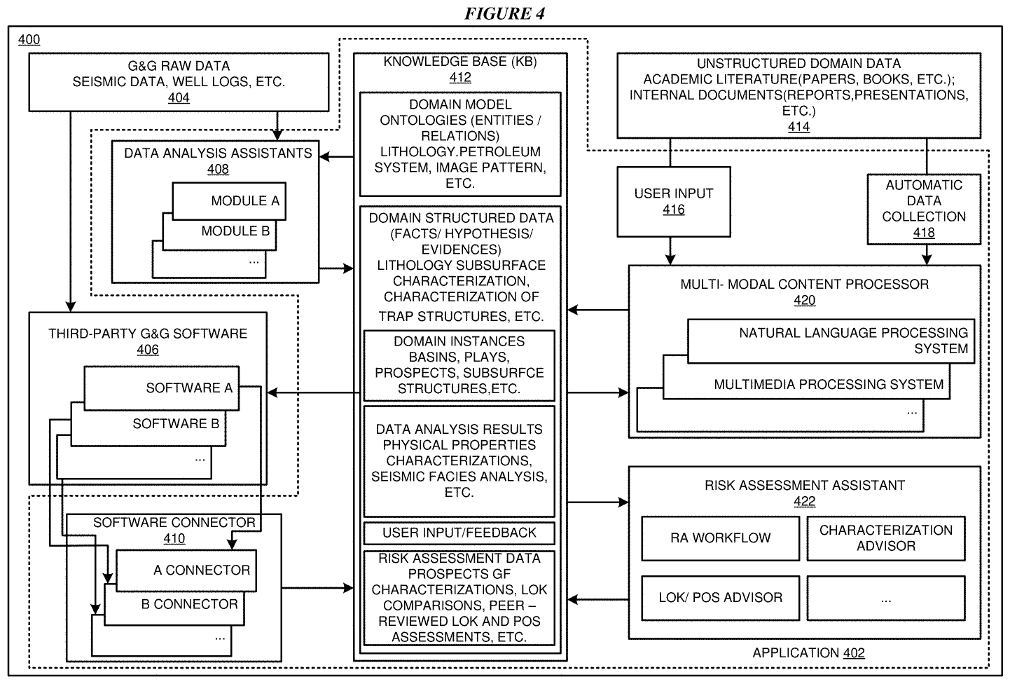

With reference to FIG. 4, this figure depicts a block diagram of another exemplary architecture 400 for enhanced consistency in geological risk assessment through continuous machine learning in accordance with an illustrative embodiment. The example embodiment includes an application 402. In a particular embodiment, application 402 is an example of application 105 of FIG. 1.

In the embodiment, application 402 receives geological and geophysical (G&G) data raw data 404, third-party G&G software inputs 406, and unstructured domain data 414. In particular embodiments, G&G raw data 404 includes data associated with one or more prospects captured from sources such as seismic data and well data from exploration activity, third-party G&G software inputs 406 include geological factors and other data received from one or more third-party G&G software tools (software A, Software and unstructured domain data 414 includes academic literature (such as academic papers, books, etc.) and other unstructured data containing information useful for making risk assessment decisions.

Application 402 includes data analysis assistants 408, software connectors 410, KB 412, user input component 416, automatic data collection component 418, multi-modal content processor 420, risk assessment assistant 422. Data analysis assistants 408 include one or more modules configured to provide geological interpretation of G&G raw data 404 and provides the interpreted G&G raw data to knowledge base 412 as domain structured data. Software connectors 410 include one or more connectors configured to translate analysis performed in third-party software 406 or other analysis tools to an ontology of KB 412 as domain structured data.

In the embodiment, KB 412 includes domain model ontologies defining entities and relationships for the domain structured data. In particular embodiments, the domain model ontologies include lithology, petroleum system, and image pattern ontologies relating entities found within G&G raw data 404 usable to perform risk analysis. KB 412 further includes domain structured data which includes facts, hypotheses, and evidences such as lithology subsurface characterization and trap structure characterizations. The domain structured data further includes domain instances such basins, plays, prospects, and subsurface structures. The domain structured data further includes data analysis results such as physical properties characterizations, and seismic facies analysis. The domain structured data further includes user input/feedback data and risk assessment data. In particular embodiments, the risk assessment data includes prospect geological factor characterizations, LOK comparisons, and peer-reviewed LOK and POS assessments.

Multi-modal content processor 420 is configured to receive unstructured domain data 414 via one or more of user input component 416 or automatic data collection component 418 and process unstructured domain data 414 to produce domain structured data. Multi-modal content processor 420 further stores the domain structured data in KB 412. In one or more embodiments, multi-modal content processor 420 processes unstructured domain data 414 using one or more of a natural language processing (NLP) system and a multimedia processing system to parse and extract content from unstructured domain data 414 and convert the content to domain structure data. Risk assessment assistant 422 includes a risk assessment workflow component configured to generate a risk assessment workflow, a characterization advisor component configured to characterize geological factors associated with one or more prospects, and a LOK/POS advisor component to assess LOK and POS values of the one or more prospects.

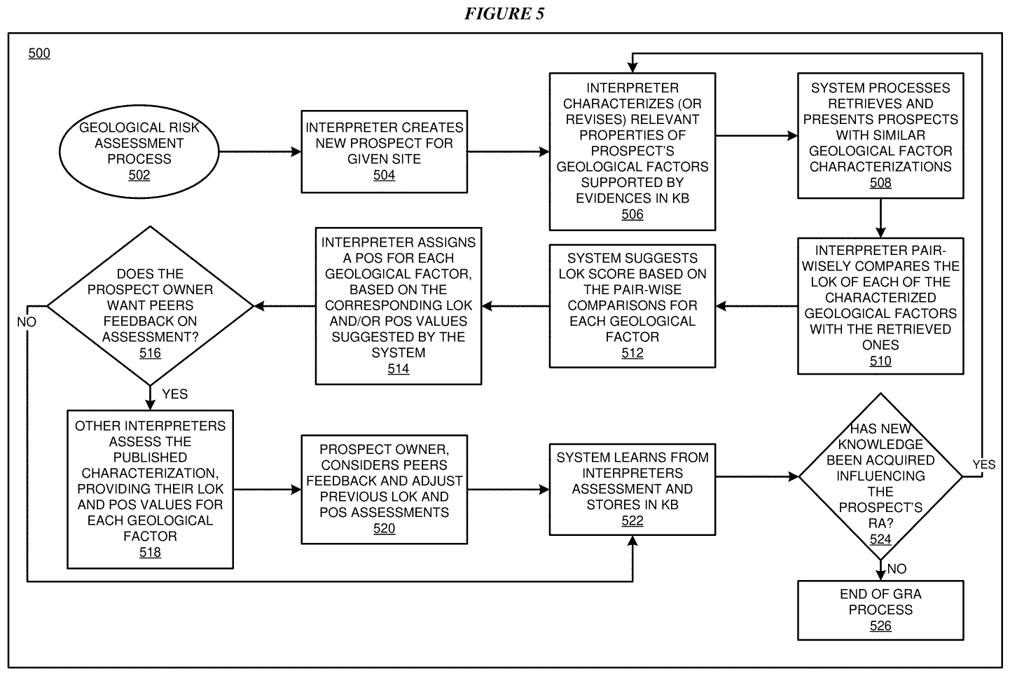

With reference to FIG. 5, this figure depicts an exemplary workflow 500 for geological risk assessment in accordance with an illustrative embodiment. In block 502, a geological risk assessment process is initiated by a system implemented by application 402. In block 504, an interpreter creates a new prospect for a given site. In block 506, the interpreter characterizes or revises relevant properties of the prospect's geological factors supported by evidences in KB 412. In block 508, the system processes and retrieves prospects with similar geological factor characterizations as the given site from KB 412 to the interpreter, and presents the prospects with similar geological factor characterizations to the interpreter. In block 510, the interpreter performs a pair-wise comparison of the LOK of each geological factor characterized by the interpreter with the retrieved geological factors of the prospects.

In block 512, the system suggests a LOK score based on the pair-wise comparison for each geological factor. In block 514, the interpreter assigns a POS for each geological factor based upon the corresponding LOK and POS values suggested by the system. In block 516, the interpreter determines whether the interpreter wants peer feedback on the interpreter's assessment. If the interpreter does not desire peer feedback, workflow 500 continues to block 522 as further described herein.

If the interpreter desires peer feedback, in block 518 other interpreters or users assess the published characterization, providing their own LOK and POS estimates for each geological factor. In block 520, the prospect owner interpreter receives peer assessments feedback, and adjusts the interpreter's estimates based on the peer assessments feedback. In block 522, the system learns from the interpreter's assessment and stores the interpreter's assessment in KB 412 as domain structured data.

In block 524, the system determines if new knowledge has been acquired that could potentially influence the prospect's risk assessment such as the receiving of new raw data or unstructured data. If new knowledge has been acquired, workflow 500 returns to block 506 to trigger a characterization revision by the interpreter. If no new knowledge has been acquired, the risk assessment is considered stable and workflow 500 continues to block 526. In block 526, the GRA process ends. In particular embodiments, the system computes a profitability estimation on the new prospect based upon the geological risk assessment as a next stage of a petroleum exploration workflow.

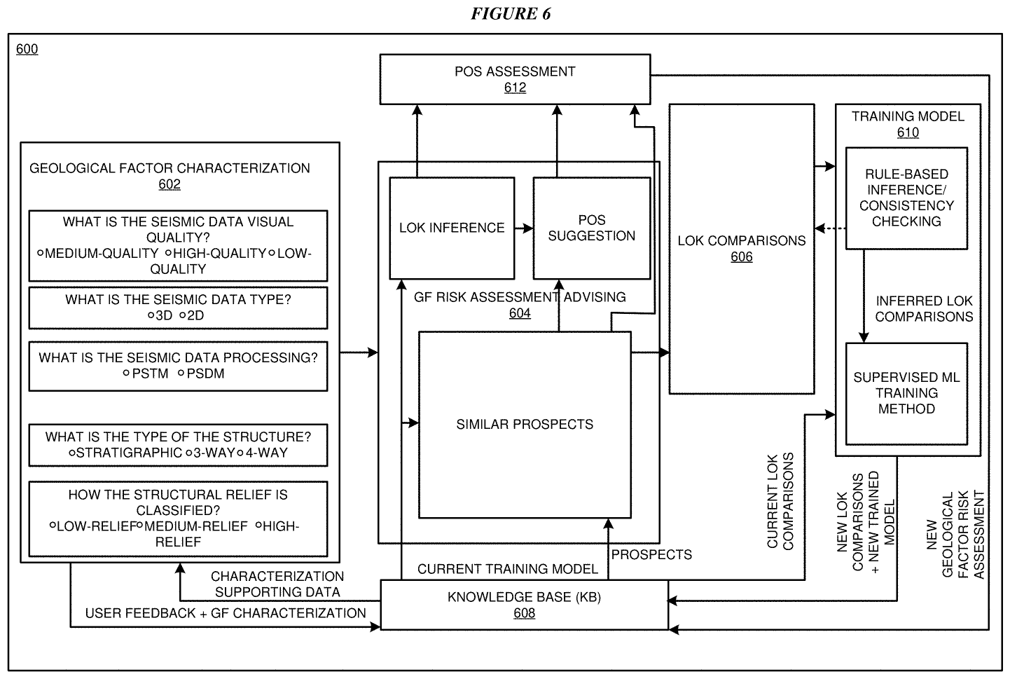

With reference to FIG. 6, this figure depicts an example process 600 for continuous learning in geological factor risk assessment in accordance with an illustrative embodiment. FIG. 6 illustrates a process of LOK and POS assessments for a particular geological factor of a given prospect. In block 602, an expert (e.g., an interpreter or other subject-matter expert) characterizes a geological factor using a user interface. In a particular embodiment, the system presents the expert with a series of questions to enable the expert to characterize the geological factor. Example questions may include: asking the expert “What is the seismic data visual quality?” and the expert may answer one of “MEDIUM-QUALITY”, “HIGH-QUALITY” and “LOW-QUALITY”; asking the expert “What is the seismic data type?” and the expert may answer one of “3D” and “2D”; asking the expert “What is the seismic data processing?” and the expert may answer one or “PSTM” or “PSDM”; asking the expert “What is the type of the structure?” and the expert may answer one of “stratigraphic”, “3-way” or “4-way”; and asking the expert “How the structural relief is classified?” and the expert may answer one of “low-relief”, “medium-relief”, or “high-relief”.

In a GF risk assessment advising block 604, the system retrieves a set of prospects with similar characterization to be used as reference for the assessment. In a LOK comparison block 606, the expert pair-wise compares the LOK of the prospect to the LOKs of the similar prospects. For each similar prospect, the expert evaluates the prospects characterization and related evidences, giving feedback whether the prospect has a higher, lower or similar LOK. In a training model block 610, the system retrieves previous comparisons stored in KB 608 and use rule-based inference to detect and warn the expert of possible inconsistencies with the provided comparisons. The system uses explicit and inferred comparisons to train a machine learning (ML) model that given a characterization and its evidences outputs a corresponding LOK score consistent to the experts' comparisons.

Training model block 610 outputs new LOK comparisons and a new trained model to KB 608. The model is then used to infer the LOK score of the current prospect characterization. Along with this LOK inference, the system also provides a suggestion of a POS consistent with the corresponding LOK scale. The system also takes into account previous assessments and other relevant information from similar prospects, such as successful drilling results. In POS assessment block 612, experts assess the geological factor POS constrained to the range of values defined by the current inferred LOK and provides a new geological factor risk assessment to KB 608. As more feedback and knowledge are provide to KB 608, the assessment advising process is continuously enhanced.

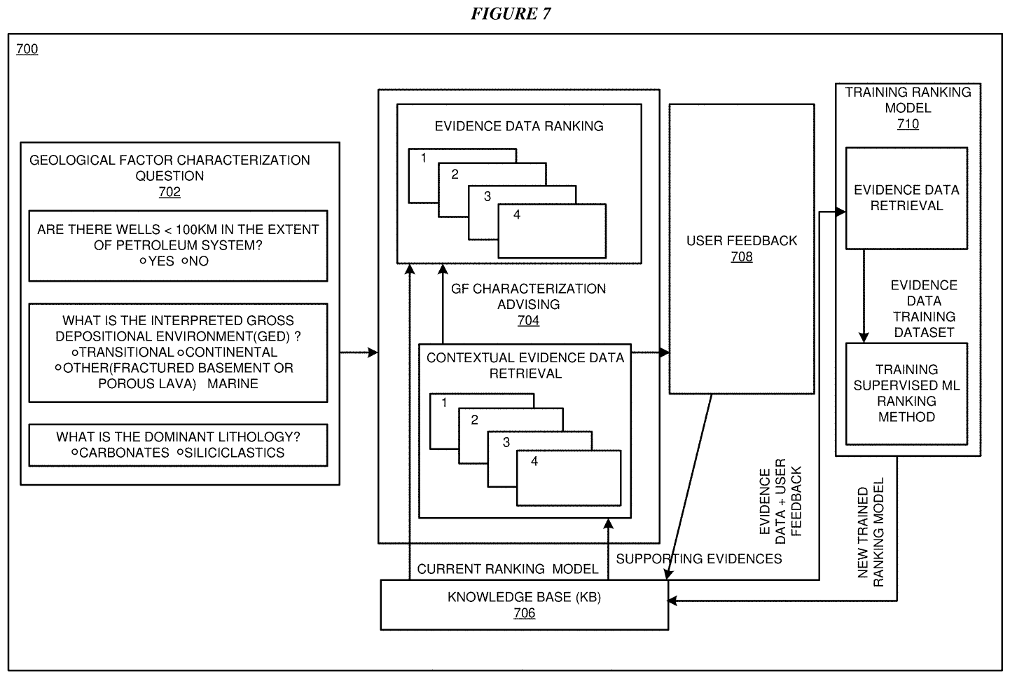

With reference to FIG. 7, this figure depicts an example process 700 for continuous learning in geological factor characterization in accordance with an illustrative embodiment. In a geological factor characterization question block 702, the system presents a questionnaire for each geological factor, capturing relevant properties that may influence the POS measure.

Example questions for the questionnaire may include: asking the expert “Are there wells <100 KM in the extent of the petroleum system?” and the expert may answer one of “YES” or “NO”; asking the expert “What is the interpreted gross depositional environment (GED)?” and the expert may answer one of “transitional”, “continental” or “other (fractured basement or porous lava) marine”; and asking the expert “What is the dominant lithography?” and the expert may answer one or “carbonates” or “siliciclastics”.

GF characterization advising block 704 supports experts by retrieving and ranking contextual evidence data related to concepts present in each question based upon a current ranking model and supporting evidences retrieved from KB 706. These evidences include structured knowledge in KB 706 such as seismic data analyses, facts extracted from papers, expert annotations, etc. After retrieving these evidences, experts can provide user feedback 708 about the relevance of such advice. The system uses this user feedback 708 to train a recommendation ranking model 710 using a supervised machine learning (ML) ranking method. Training ranking model 710 provides a new ranking model to KB 706. As more feedback and knowledge are fed to KB 706, the characterization advising process is continuously enhanced.

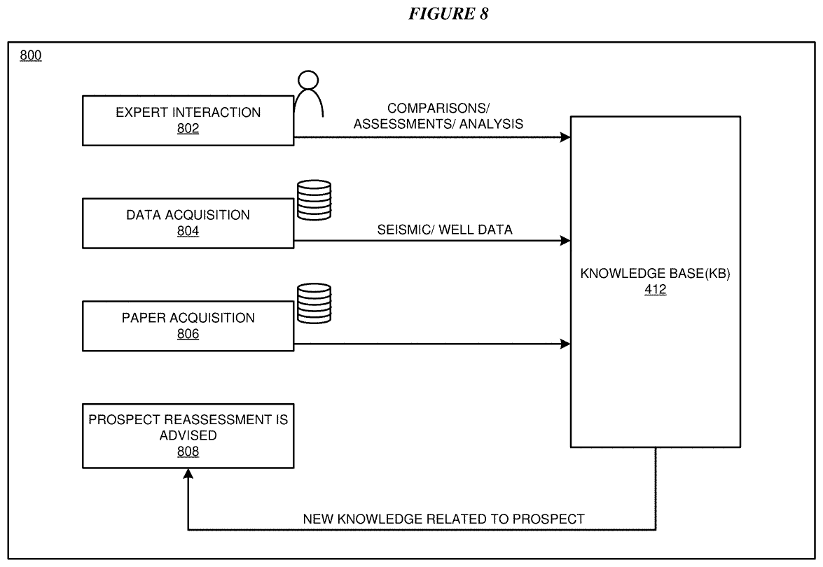

With reference to FIG. 8, this figure depicts an example process 800 for geological risk reassessment in accordance with an illustrative embodiment. Since knowledge is structured in KB 412, the system is able to monitor relevant changes regarding concepts and resources and trigger new LOK and POS assessments for a site. New resources in the form of expert interaction 802 to providing new pair-wise LOK comparisons, new assessments, and data analysis, data acquisition 804 providing seismic or well data, and paper acquisition 806 providing new papers related to a given prospect. As a result of receiving new knowledge related to a prospect, the system triggers an advisement for a prospect reassessment 808.

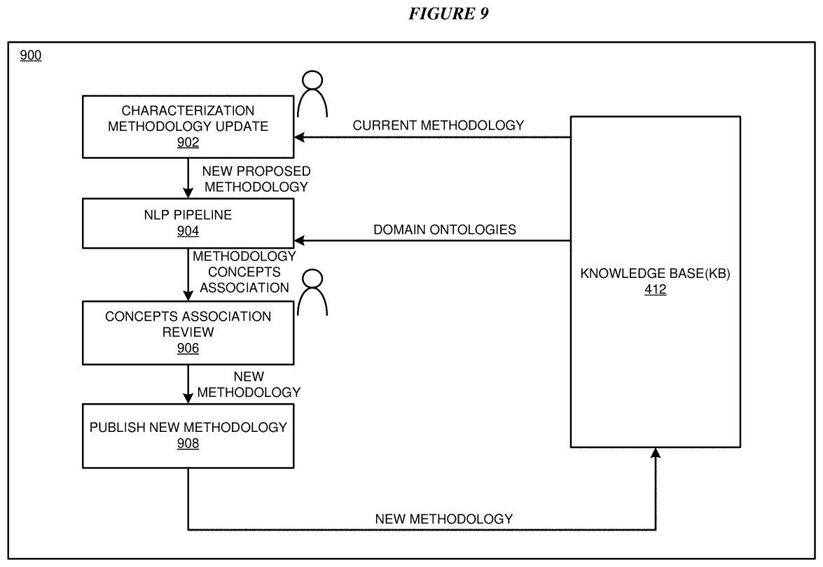

With reference to FIG. 9, this figure depicts an example process 900 for geological factor characterization methodology update in accordance with an illustrative embodiment. Traditionally, characterization methodologies of geological factors are fixed. However, technology evolution or new exploration frontiers may require an adaptation of such methodologies. One or more embodiments provide for updating relationships among questions and answers with the domain concepts mapped in the KB ontologies. In a characterization methodology update block 902, an expert proposes a new methodology by changing the questionnaire or aspects of the ontology in KB 412. An NLP pipeline 904 processes the proposed changes of the geological factor characterization methodology and automatically extracts concepts and relationships of this new methodology using the domain ontologies represented in KB 412. In a concepts association review block 906, the expert reviews the extracted associations. In block 908, the expert publishes the new methodology and the new methodology is stored in KB 412.

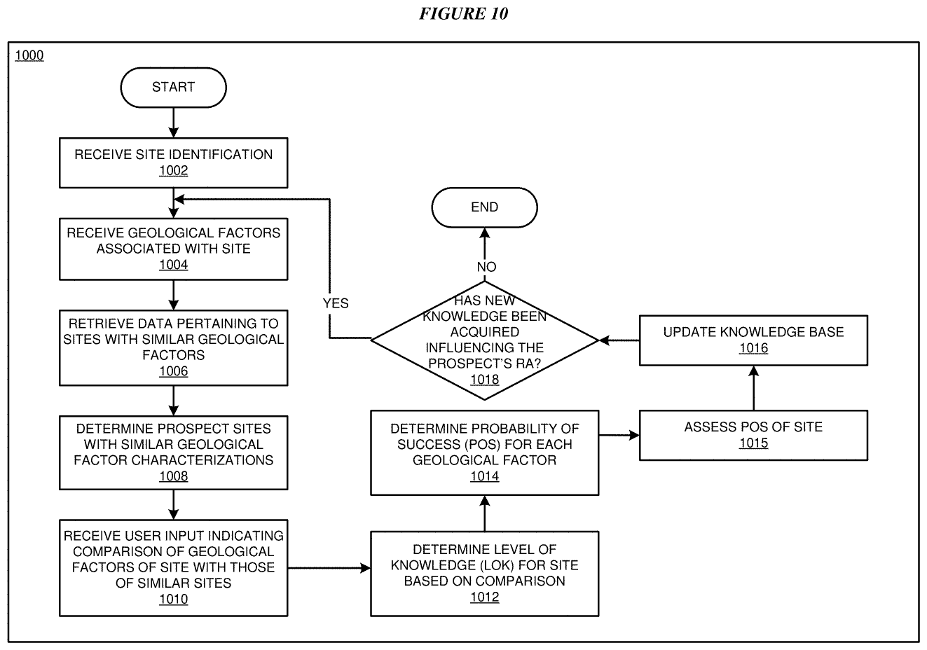

With reference to FIG. 10, this figure depicts a flowchart of an example process 1000 for enhanced consistency in geological risk assessment through continuous machine learning in accordance with an illustrative embodiment. In block 1002, application 105 receives a site identification of a prospect for which geological risk assessment is to be performed. In block 1004, application 105 receives geological factors associated with the site from a user such as an interpreter or other expert. In block 1006, application 105 retrieves data pertaining to site with similar geological factors from a knowledge base such as knowledge base 109 or 412.

In block 1008, application 105 determines prospect sites with similar geological factor characterizations. In block 1010, application 105 receives user input from the user indicating a pair-wise comparison of geological factors of the site with those of the similar sites. In block 1012, application 105 determines a level of knowledge (LOK) for the site based upon the comparison and determines a suggested POS for the site based upon the LOK. In block 1014, application 105 determines a probability of success (POS) for each geological factor of the similar sites. In block 1015, application 105 determines a probability of success for the site, and assesses the probability of success of the site based upon the level of knowledge of the site, the suggested probability of success for the site, and the probability of success for each of the geological factors the similar sites to produce a geological risk assessment of the site.

In block 1016, application 105 updates the knowledge base based upon the POS assessment. In block 1018, application 105 determines whether new knowledge has been acquired that will potentially influence the GRA of the site. If new knowledge has been acquired, process 1000 returns to block 1004. If no knowledge has been acquired that will potentially affect the GRA of the site, process 1000 then ends.

Thus, a computer implemented method, system or apparatus, and computer program product are provided in the illustrative embodiments for enhanced consistency in geological risk assessment through continuous machine learning in accordance with an illustrative embodiment and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for geological risk assessment, the method comprising:
receiving a first set of geological factors associated with a first site;
retrieving data pertaining to at least one second site with a second set of geological factors similar to first set of geological factors of the first site;
receiving a user input indicating a comparison of the first set of geological factors to the second set of geological factors;
determining a level of knowledge of the first site based upon the comparison;
determining a suggested probability of success for the first site based upon the level of knowledge;
determining a probability of success for each of the geological factors of the second set of geological factors;
determining a probability of success for the first site; and
assessing the probability of success of the first site based upon the level of knowledge of the first site, the suggested probability of success for the first site, and the probability of success for each of the second set of geological factors.

2. The method of claim 1, wherein the data is retrieved from a knowledge base.

3. The method of claim 2, further comprising:
updating the knowledge base based on the assessment.

4. The method of claim 2, further comprising:
receiving unstructured data associated with the second site;
converting the unstructured data to structured data; and
storing the structured data in the knowledge base.

5. The method of claim 4, wherein converting the unstructured data to structured data includes processing the unstructured data using natural language processing techniques.

6. The method of claim 2, further comprising:
receiving measurement data associated with the second site;
analyzing the measurement data to provide a geological interpretation of the measurement data; and
storing the interpreted data in the knowledge base as structured data.

7. The method of claim 1, wherein the comparison is a pair-wise comparison of the first set of geological factors and the second set of geological factors.

8. The method of claim 1, further comprising:
receiving feedback associated with the assessment of the probability of success of the first site from one or more other users; and
adjusting the assessment based on the feedback.

9. The method of claim 1, wherein the assessment is performed by a subject-matter expert.

10. A computer usable program product comprising one or more computer-readable storage devices, and program instructions stored on at least one of the one or more storage devices, the stored program instructions comprising:
program instructions to receive a first set of geological factors associated with a first site;
program instructions to retrieve data pertaining to at least one second site with a second set of geological factors similar to first set of geological factors of the first site;
program instructions to receive a user input indicating a comparison of the first set of geological factors to the second set of geological factors;
program instructions to determine a level of knowledge of the first site based upon the comparison;
program instructions to determine a suggested probability of success for the first site based upon the level of knowledge;
program instructions to determine a probability of success for each of the geological factors of the second set of geological factors;
program instructions to determine a probability of success for the first site; and
program instructions to assess the probability of success of the first site based upon the level of knowledge of the first site, the suggested probability of success for the first site, and the probability of success for each of the second set of geological factors.

11. The computer usable program product of claim 10, wherein the data is retrieved from a knowledge base.

12. The computer usable program product of claim 11, further comprising:
program instructions to update the knowledge base based on the assessment.

13. The computer usable program product of claim 11, further comprising:
program instructions to receive unstructured data associated with the second site;
program instructions to convert the unstructured data to structured data; and
program instructions to store the structured data in the knowledge base.

14. The computer usable program product of claim 13, wherein converting the unstructured data to structured data includes processing the unstructured data using natural language processing techniques.

15. The computer usable program product of claim 11, further comprising:
program instructions to receive measurement data associated with the second site;
program instructions to analyze the measurement data to provide a geological interpretation of the measurement data; and
program instructions to store the interpreted data in the knowledge base as structured data.

16. The computer usable program product of claim 10, wherein the comparison is a pair-wise comparison of the first set of geological factors and the second set of geological factors.

17. The computer usable program product of claim 10, further comprising:
program instructions to receive feedback associated with the assessment of the probability of success of the first site from one or more other users; and
program instructions to adjust the assessment based on the feedback.

18. The computer usable program product of claim 10, wherein the computer usable code is stored in a computer readable storage device in a data processing system, and wherein the computer usable code is transferred over a network from a remote data processing system.

19. The computer usable program product of claim 10, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to receive a first set of geological factors associated with a first site;
program instructions to retrieve data pertaining to at least one second site with a second set of geological factors similar to first set of geological factors of the first site;
program instructions to receive a user input indicating a comparison of the first set of geological factors to the second set of geological factors;
program instructions to determine a level of knowledge of the first site based upon the comparison;
program instructions to determine a suggested probability of success for the first site based upon the level of knowledge;
program instructions to determine a probability of success for each of the geological factors of the second set of geological factors;
program instructions to determine a probability of success for the first site; and
program instructions to assess the probability of success of the first site based upon the level of knowledge of the first site, the suggested probability of success for the first site, and the probability of success for each of the second set of geological factors.
